(19) United States
(12) Patent Application Publication
(10) Pub. No.: US 2008/0262941 A1
(43) Pub. Date: Oct. 23, 2008

(54) System and Method for Purchasing and Reselling Online and Offline Subscriptions, Service Contracts and Memberships and Paid Website Access

(76) Inventors: Edward FEINER, Harrison, NY (US); Ajay Rajani, New York, NY (US)

Correspondence Address: Novak Druce & Quigg LLP, 1300 I Street NW, Suite 1000 West Tower, Washington, DC, 20005, US

(21) Appl. No.: 12/106,583

(22) Filed: Apr. 21, 2008

Related U.S. Application Data
(60) Provisional application No. 60/907,851, filed on Apr. 19, 2007.

(51) Int. Cl. G06Q 30/00; G06Q 20/00

(52) U.S. Cl. 705/26

(57) ABSTRACT

A method and system for purchasing and reselling the remaining (i.e., remainder) term of subscription providing a web page for display by a registered user containing a buy list, the buy list includes an inventory of one or more remainder subscriptions available for sale, and the buy list includes price and duration of remaining term. A purchase request is sent to an owner/designee of the remainder subscriptions for sale on the buy list. The purchase price is transferred from a user's account, and the purchase price includes a transaction fee. The offeror of the subscription is notified that the particular remainder subscription has been transferred to the user, and the user is provided with a password or other information to obtain access to the remainder subscription. The method and system also entertains offers for sale of remainder subscriptions by users. It is preferred that all user sales and user purchases of remainder subscriptions occur to/from the owner/designee.

This application claims priority from Provisional Application Nos. 60/860,491 filed Nov. 22, 2006 and 60/907,851 filed Apr. 19, 2007, each of which is hereby incorporated by reference.

### BACKGROUND OF THE INVENTION

1. Field of the Invention

The field of the invention is related to buying and reselling items online and offline. More particularly, the field of the invention is related to the purchase of subscriptions, service contracts and memberships and a system and method for assignment heretofore unknown.

2. Description of the Related Art

There is an ever-increasing number of businesses offering subscriptions, service contracts, memberships and similar service and product agreements that require a fixed payment for a fixed period of time without the purchaser's ability to obtain the return of any portion of the payment in the event that the purchaser should desire to terminate the service prior to the end of the fixed time period for which the fee has been paid. These include websites that require payment for access offering online subscriptions for periodicals, including financial periodicals, software services, file sharing, music, diet programs, survey services and other products and services. They also include similar offline products and services as well as cell phone contracts, gym memberships, country club memberships, museum memberships, private club memberships, car leases, apartment leases, software and other service agreements and periodic transportation services such as Metro North tickets and Metrocards. These fees can range from a nominal charge up into the hundreds of dollars or more range. Online and offline subscription, membership and service contract providers generally attempt to “lock-in” their customers for extended periods of time, ranging from several months to as long as three years.

The agreements having longer terms usually result in a lower price per service or product charged to the user, in an attempt to entice users to lengthen their purchase commitments. In turn, such agreements stabilize the offeror's base of users, as well as income.

In today's fast-paced world, user's sometimes find that they no longer have the time to use the product or service, or visit internet sites that they have subscribed to, and/or that there may no longer be a need to use the product or service due to a change in work responsibility, new employer, change in residence or lifestyle, etc. However, the user may be locked in for a period of time during which the product or service is no longer used, wasting resources.

At the same time, there can be other people who subsequently feel the need to purchase the same product or service that is no longer wanted by the aforementioned user.

Accordingly, there is a need in the art to match disinterested users and potential new users together to permit the disinterested user to recoup at least a portion of the costs for a product or service that is no longer wanted. There is also a need, at least by publishers and other online service offerors to have a user base that is actually using the service and/or visiting the website, because the advertisers sometimes pay rates based on the number of website clicks made by visitors.

### SUMMARY OF THE INVENTION

The claimed invention provides a method and system for purchasing the remaining (i.e., remainder) term of a service or right to use a product. For the purposes of this application, the term “subscription” shall be construed to mean the service or product for which a user has paid but no longer requires or desires the use of, and the term “remainder subscription” shall be construed to mean the remaining period of time that the existing user can continue to use the subscription including, where required, access or visits to an Internet site that belongs to that existing user.

The claimed invention includes a method of transferring access to subscriptions and, where required, Internet pay sites, which includes the steps of:

(a) providing for an online buy list for display by an interested purchaser, such buy list comprising one or more remainder subscriptions that are available for purchase from an interested seller;

(b) receiving a purchase request for a particular remainder subscription on the buy list;

(c) determining a current value of the remainder subscription selected by the interested purchaser according to the following formula:

(1- y/x) (z) (1)

wherein y=number of days transpired since the particular remainder subscription started,
x=number of total days in duration for the first remainder subscription; and z=price of the remainder subscription; and

(d) providing the interested purchaser with an offering price for the purchase of the particular remainder subscription that is substantially based on the current value in step (c) and a transaction charge.

In addition, a method according to the current claimed invention may include paying the interested seller in credits/tokens representing monetary value substantially equivalent to the offering price, wherein the credits are good for use only by the interested seller to purchase a remainder subscription from the buy list now that he/she has sold one subscription.

With regard to the purchase price, for example, the interested purchaser either receives a custom quote after selecting a particular remainder subscription or alternatively, the buy list already contains the current prices for some or all of the remainder subscriptions as part of the display initially viewed on the website by the interested purchaser.

With regard to the remainder subscriptions for sale, in one aspect of the invention, all of the remainder subscriptions on the buy list have been assigned to a common designee from a previous purchaser. This common designee can also be referred to as a third party entity. Typically, all of the users must be registered users of the website to participate in the sale or purchase of remainder subscriptions.

Once the purchaser has agreed to purchase a subscription, at the server side the steps of (i) transferring ownership of the remainder subscription to a third party entity may occur, wherein the third party entity becomes the owner and interested seller. Alternatively, the third party entity may own the remainder subscriptions before display on the website. It is even possible that a consignment arrangement may be used for the display and the sale of the remainder subscriptions. If the buy list did not contain a price for the remainder subscription, then the sub-steps may include: (i) updating the buy list to include the first remainder subscription selected. The website may contain the entire inventory, or selected portions.

In addition, a system that performs the sale of remainder subscriptions according to the claimed invention includes a series of interconnected modules. For example, a user module facilitates a user to register, log into the system and update user account information, such as address, telephone or email address of the user. A buy subscription module facilitates a user to purchase a subscription, while a sell subscription module facilitates a user to sell a subscription. An administration module can track the operation of the other modules, including the viewing of user information, update information regarding the name of a third party entity which purchases the remainder subscription.

In one embodiment of the invention, each of the modules would be used to provide dynamic web pages for operation on the Microsoft.Net framework, using DHTML and ASP.NET, to provide compiled code for faster speed of delivery, language compatibility to allow language independence, enhanced security and advanced configuration and optimization facility.

The system can be accessed over any wire or wireless communication systems including the Internet, LAN, WAN, satellite, RF, fiber optic, etc., and its operational software would be typically located on a web server. However, it is possible that the inventory of subscriptions could be large enough to be stored on a database, and the database be periodically updated. The computer program to operate the system would be executable on machine-readable data, typically on a server side program. The purchasers and sellers would click on links on the website that would cause the program on the server side to provide the bulk of the functionality.

Typically, the buy and sell modules would access an SQL (Structured Query Language) server, and the server-side software would require a website to be hosted with supporting SQL Server. However, a person skilled in the art would understand and appreciate that the claimed invention can utilize database access in forms other than by SQL Server.

### BRIEF DESCRIPTION OF THE DRAWINGS

For purposes of illustration and not intended to limit the scope of the invention in any way, the aforementioned and other characteristics of the invention will be clear from the following description and the accompanying drawing wherein:

FIG. 1A is a diagram of a system for selling subscriptions according to the claimed invention;

FIG. 1B is a diagram of the system modules according to a first aspect of the invention;

FIG. 2A is a flow chart of one aspect of the invention that illustrates the steps when a user purchases a remainder subscription according to the claimed invention.

FIG. 2B is a flow chart of another aspect of the invention, showing how a third party entity can obtain remainder subscriptions from users, which are subsequently resold/transferred to another user; and

FIG. 3 is a diagram showing the operational features as web pages that support both a method and system according to the claimed invention.

### DETAILED DESCRIPTION OF THE INVENTION

While a detailed description of the invention follows in conjunction with the above-identified drawings, it is to be understood that the examples are for purposes of illustration and not of limitation. A person of ordinary skill in the art appreciates that there can be several variations of the examples shown and described herein that are nonetheless within the spirit of the invention and the scope of the appended claims.

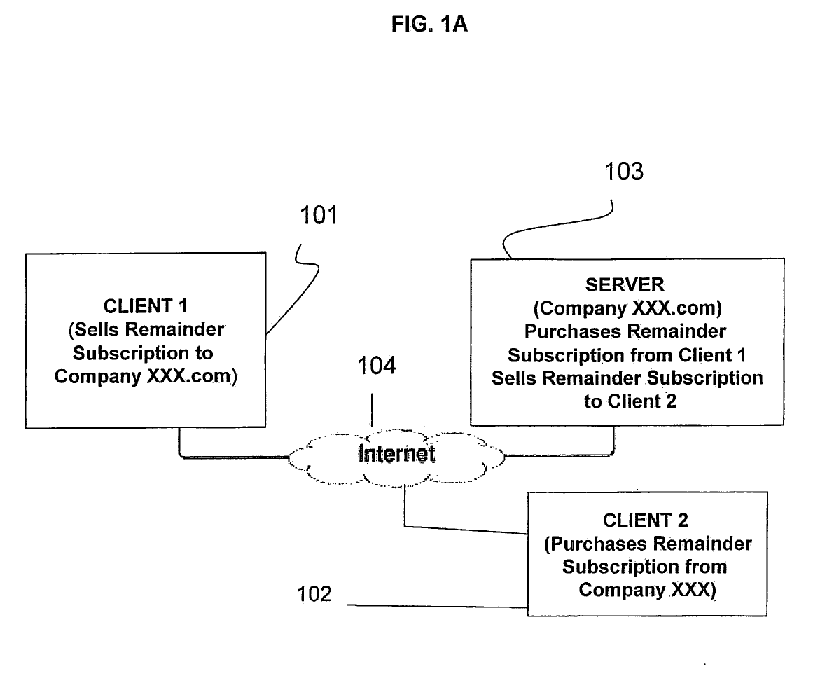

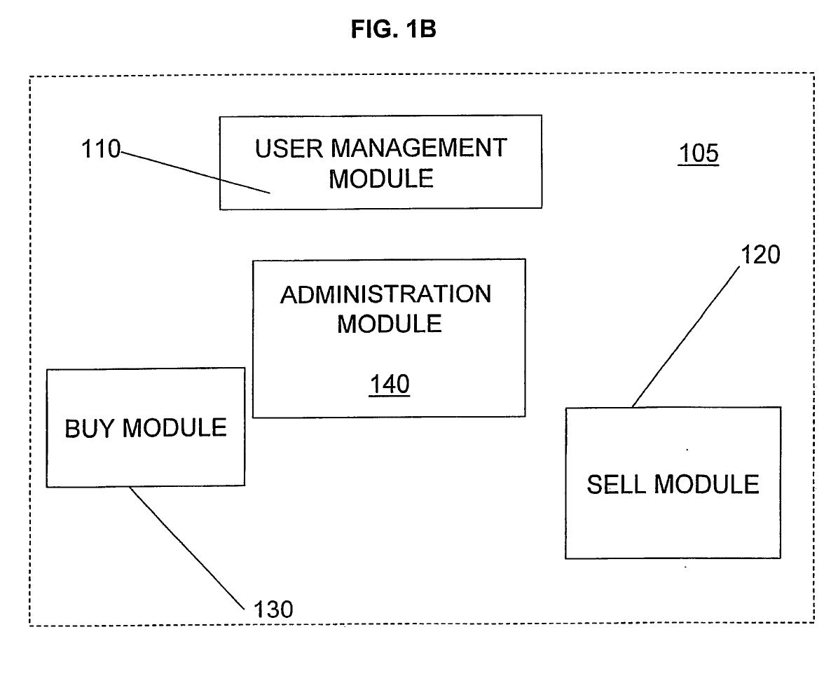

FIG. 1A is a diagram of a system for selling remainder subscriptions according to the claimed invention. In the particular example shown, clients 101 and 102 are users that are in communication with the server 103, which hosts the software that renders the system operational. Typically, the clients 101, 102 are devices that can access the server 103 including but not limited to personal computers, laptop/notebook computers, personal digital assistants (PDA's) with browser capability, mobile telephones with accessibility to the server, thin clients, etc.

The communication between clients 101, 102 and server 103 is shown over the internet 104 including but not limited to TCP/IP, however any of type of network (e.g. WAN) could be used, and the communication may be made over telephone lines, broadband lines such as T1, T3, fiber optic lines, wireless communication, DSL, satellite links, etc. It is also possible that the server 103 may be a proxy server (not shown) and that a host server (not shown) is accessed via the proxy server.

Still referring to FIG. 1A, the particular example shown provides that a common designee/third party entity (“Company XXX”) purchases a remainder subscription from a first user/Client 101, and then in response to receiving a purchase request from Client 2, re-sells the remainder subscription s. It is also possible that the third party entity merely assists in the forwarding of the ownership of the subscription and does not actually receive ownership of the remainder subscription.

The server 103, which has server side software, typically is accessed by the client 101,102 via a website. The website has links that connect to the server 103 and provide functionality for the server side software. The operational aspects of the invention are provided by a series of modules, most, or even all of which, reside on the server 103.

It is preferable that the website pages are dynamic to the greatest extent possible, and configurable through administrative options.

FIG. 1B, provides an overview of the modules 105 that are part of a system according to the Claimed invention. These modules may be comprised of hardware, software or firmware, but preferably would be part of a server side data structure, as an executable program on machine-readable media.

According to FIG. 1B, a user management module 110 facilitates a user to register with the entity providing the website, as well as log n and update any user account information.

In addition, according to a particular aspect of the invention, a user would be required to register not only with the third part entity (e.g. Company XXX.com website) but the user also needs to possess a membership or right with the third party entity to buy and/or sell remainder subscriptions. Typically, a membership or rights agreement will be in effect over a period of time (e.g., three months to three years) and set forth the rights and responsibilities of the subscription owner. The user must confirm that he/she agrees to the specified rules before, during, or subsequent to the confirmation that the user provides payment information, usually in the form of credit card or checking account information.

With regard to registration, the user management module 110 will provide a page used to create a new user and/or update other pertinent information, and the page captures some or all of the following information:

User ID

Password

Name

Email

Home Address

Credit Card

Billing Address.

The registration page has a “submit” bar or link, which can be in the form of Hyper Text Mark-up Language (HTML) or Extensible Mark-up language (XML). When the submit link is activated, the information on page is forwarded to a User Account Page, at which there is an update of user information after passing through validation checks logged in state. A user is typically directed to the use account page after a successful registration or log in. However, it Is within the spirit of the invention and the scope of the appended claims that the user could be directed to another page than a user page, or there could even be a rotation of two or more pages that the user is first directed to after successfully registering or signing on. The User Account Page can have the following links:
(1) Update Account Preference: This link will redirect the user to the Registration page opened in Edit Mode;

(2) Search: Directs User to Search Parameter Page where user can select search criteria; and

(3) Sell subscription: Directs to sell subscription page after user selects a subscription.

The sell module 120 facilitates the submittal of a request for sale of a remainder subscription by a user. The subscription relating to this remainder subscription may have been purchased through the current website, or it could have been purchased independent of the website. In such a case where the subscription was not purchased through the current system, the seller would have to provide the information, such as the subscription number, user id, and password. The user name, password, remaining term, etc. all must be verified by the system before the seller would receive credits and the before the current remainder subscription could be purchased by another entity.

The subscription page is then forwarded to an Administrator, who, with the aid of the Administration Module, also referred to as “Admin Module 140”, can purchase the subscription in the name of the company that provides owns/operates the service, after verifying User Account information, and then place the remainder subscription on a “Buy List” after verifying and/or purchasing the remainder subscription.

Typically, the Admin Module 140 facilitates the administrator to perform a series of activities. The Administrator Home Page generally has the following links:
Log in: Directs the Administrator to the Log in Page;
Update Account Information: Directs the Administrator to User Account Page to update account information;
View Seller Information: Directs the Administrator to a List of User's Page;
Purchase a Subscription: Directs the Administrator to a List of Subscriptions Page (a.k.a. a “Buy List”). In this case, a subscription fee is added to the Credit of the user, and transfers subscription from the User Account to the account of the owner/operator of the system once purchased.

The Buy Module 130 facilitates the purchase of subscriptions by a user, preferably from a “Buy List”. Typically, the third party entity (e.g., Company XXX.com) sells a remainder subscription to a client who recently sold a remainder subscription and was given credit from the previous transaction.

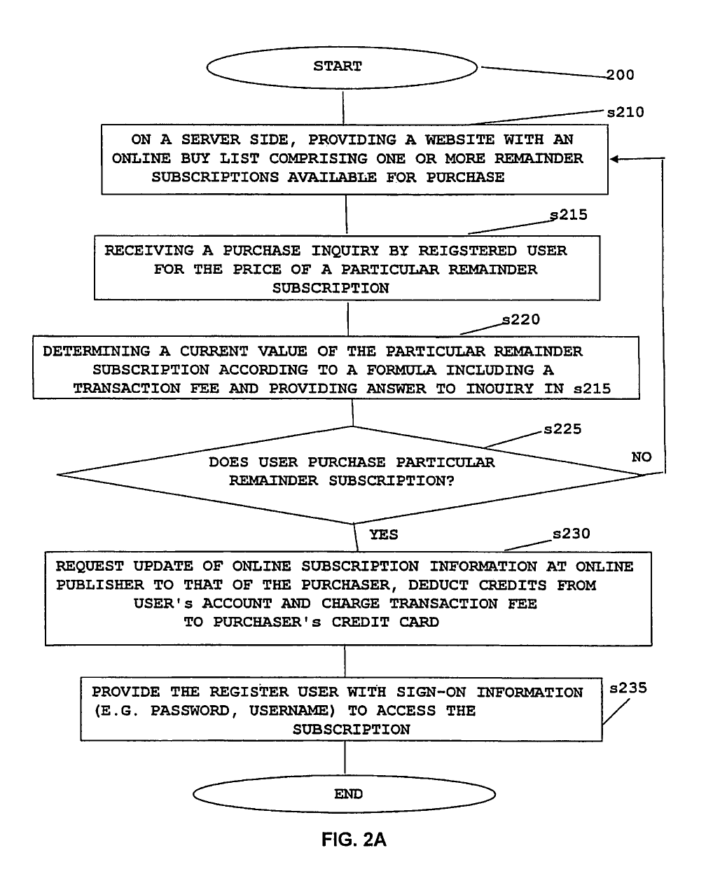

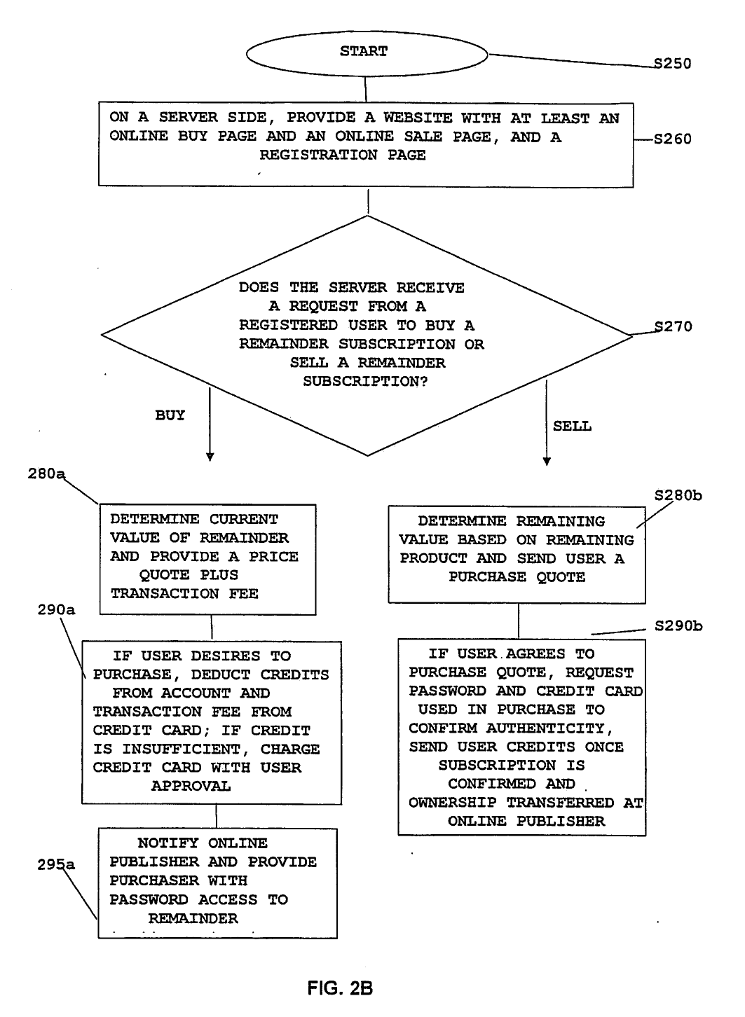

Referring to FIG. 2A, there is a flowchart providing an overview of a method for transferring access to subscriptions and, where required, Internet pay sites, according to the claimed invention.

At step (sometimes hereinafter “s”) s210, a server side, web server provides a buy list for display by an interested purchaser, wherein the buy list includes one or more remainder subscriptions that are available for purchase;

At step 215, the server receives a purchase inquiry by a registered user request for a particular remainder subscription on the buy list.

At step 220, the server determines a current value of the particular remainder subscription base on a predetermined formula and adds on a transaction fee. This information is provided to the registered user, who typically clicked a link on the Buy List page to obtain the price. A person of ordinary skill in the art appreciates that the price could be displayed on the Buy List and updated at specified intervals (e.g., daily).

Step 225 the system determines whether or not the registered user decides to purchase the remainder subscription. Once provided with price in s220 (typically in terms of credits but it could also be a direct monetary quote), and optionally some more description regarding the particular remainder subscription, the registered user either indicates a desire to purchase or continues shopping.

At step 230, If the registered user decides to purchase, the system charges the registered user by deducting the specified credits from the user's account and additionally charging a transaction fee to the user's credit card on file. Otherwise the system goes back to s210 and displays the Buy List on the website. Alternatively, the website could forward to another screen if a purchase is not made or simply wait for the registered user to log off. For safety reasons, a timer may keep track of the user's entries and log the user off after a predetermined time without activity.

With regard to s220, one way to determine a current value of the remainder subscription whose price was requested by the registered user would be to perform the following formula:

(1−y/x)(z) (1)

wherein y=number of days passed since the first remainder subscription started,

x=number of total days in duration for the first remainder subscription; and

z=price of the remainder subscription; and the transaction charge.

The transaction charge, which typically would be listed separately if the remainder subscription price is quoted in credits (e.g. 25 credits plus $5.50 transaction charge) rather than dollars is based on the following:

Transaction charge=(c) amount of credit (in dollars and cents)×predetermined percentage (2)

Thus, for example, if the credit used to purchase a remainder subscription is $25 and the predetermined percentage is 10%, the transaction fee charged to the purchaser's credit card would be $2.50, which is an amount paid in addition to the payment in credits.

In a preferred embodiment, a third party entity buys the remainder subscription and then transfers ownership upon sale. However, if the subscription does not sell for a period of time, it could be worth significantly less than it was worth when the third party entity purchased it from a registered seller. One way to protect the third party entity from loss is to refrain from releasing the credits paid for the subscription until there is a confirmed purchase. Another way to operate would be to offer the seller significantly less than the value of the remainder subscription, but this variation of the method still entails some degree of risk as even the reduced value paid for the subscription could be more than what the subscription is worth if it is not sold for a long period of time, or possibly not sold at all. Yet another solution would be to contact the offeror of the subscription or re-negotiate with the offeror of the subscription to suspend the subscription account pending resale for a reasonable period of time.

Finally, at step 235, the purchaser is provided with access to the subscription, typically with an online subscription at least one of an identifier and a password that enables the interested purchaser to retrieve and view the remainder subscription.

FIG. 2B is a flowchart that illustrates a broader version of the invention, enabling purchases of remainder subscriptions from users for resale to other users.

Referring to FIG. 2B, wherein at step 260 a website is provided with at least an online buy page (buy list), a sale page, and a registration page or other required information. Thus, a registered user is able to buy a remainder subscription, or sell an unwanted remainder subscription to the common designee/third part entity, which in turn will be added to the buy list for sale to other registered users.

At step 270, it is determined whether the user has clicked on a buy page or a sell page. If the user is interested in buying, he/she would typically either type in a name of a subscription or site, or select one displayed in the buy list. While it is shown at step 280 that a current value would then be determined according to a formula, and a transaction fee to provide the user with a price quote, it is within the spirit of the invention that the buy list could display the current price and update it automatically every day. At step 290a, the buyer would select the remainder subscription to purchase, enter payment information and forward it to the website. Typically, at step 295a, the common designee/third party entity would deduct payments from the users account and notify the offeror of the subscription that a transfer has occurred. The user would then be supplied with whatever information is necessary to access the site or otherwise obtain access to the subscription, such as a password and user name, key, etc. It is possible that the order of deducting payment and notification of the offeror of the subscription could be reversed, or carried out simultaneously. It is preferable that payment is deducted before notifying the offeror of the subscription.

However, if the user at step 270 chose to offer his/her remainder subscription for sale to the common designee/third party entity, there would have to be a determination of the remaining value. This value may or may not be the current value previously described. It could be the current value with a deduction of what is paid, in essence a transaction charge to the seller by reducing the current value by 10% and sending the user a purchase quote with that amount. It should be understood that unless the third party entity is able to suspend the remainder subscription until resold, with the passage of each day, the value of the remainder subscription is reduced, and inventories held for any length of time could result in losses because the current value will drop as the remaining term shortens.

Prior to providing the user with credits, at step 290b the administrator will confirm ownership of the remainder subscription, confirm transference, and then provide the user with the credits offered in the price quote. The credits are good for additional purchases on the website.

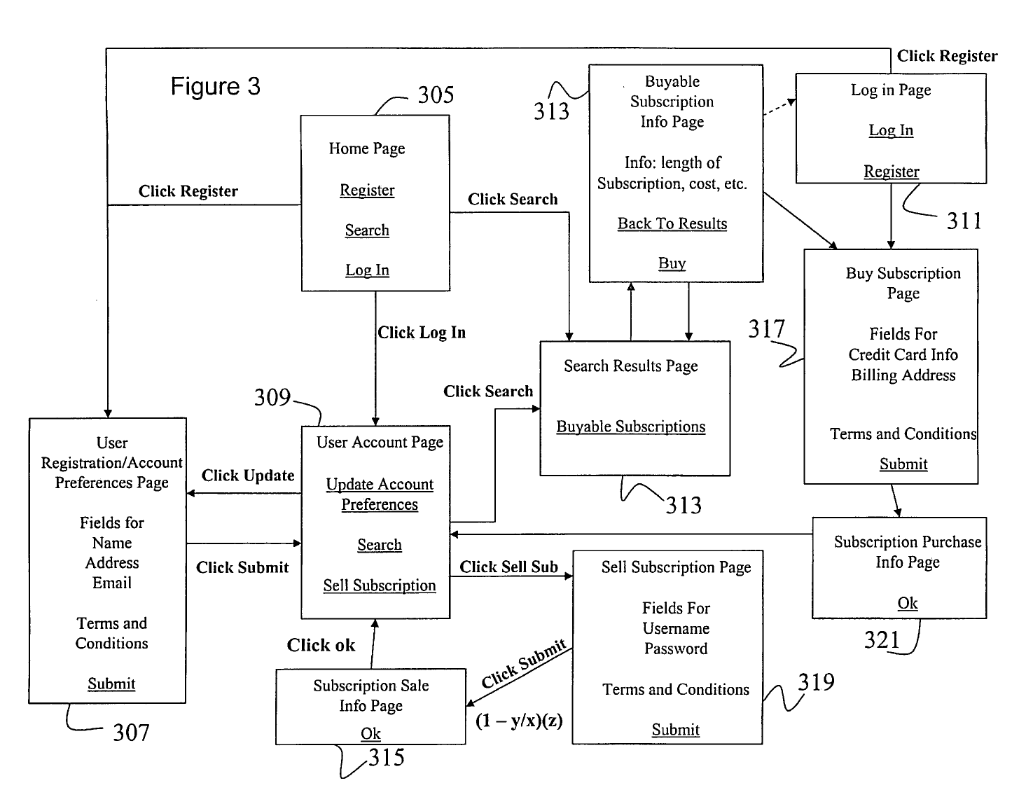

FIG. 3 is a diagram showing the operational features as web pages that support both a method and system according to the claimed invention. Item 305 is the home page, which would contain links to other pages, i.e., the registration page 307, search page 309 and log in page 311. Initially, a user must register with the website and will receive a code to log in. Once a registered user is logged in, then he/she can browse subscriptions for purchase (item 313), view the results of a buy search, preferably in the form of a buy list, or offer to sell subscriptions 315 and receive a quote 317, and actually sell subscription page 319, buy subscription page 319, and a confirmation page 321.

Various modifications may be made by persons of ordinary skill in the art that do not depart from the spirit of the invention or the scope of the appended claims. For example, the formula used to purchase subscriptions from sellers could be modified, and the determination of the price to sell subscriptions to buyers could be modified. While the invention is envisioned to be operated over the Internet, any public or even semi-private network could also be used, and the communication between the user and the third party designee could any type of communication technology now known or later developed.

We claim:

1. A method of transferring access to subscriptions and Internet pay sites, comprising the steps of:
(a) on a website, providing an online buy list for display by a user, purchaser, said buy list comprising one or more remainder subscriptions that are available for purchase;
(b) receiving a purchase inquiry for a particular remainder subscription on the buy list;
(c) determining a current value of the particular remainder subscription selected by the interested purchaser according to the following formula:
(1−y/x)(z) (1)
wherein y=number of days passed since the first remainder subscription started,
x=number of total days in duration for the first remainder subscription; and
z=price of the remainder subscription; and
(d) providing the interested purchaser with a sale price for purchase of said particular remainder subscription that is substantially based on the current value in step (c) and a transaction charge.

2. The method according to claim 1, wherein the purchase price is sent to the user for display in a web page.

3. The method according to claim 1, wherein the purchase price is sent to the user by one of e-mail and an instant message.

4. The method according to claim 2, further comprising the steps of:
(e) receiving a purchase request from the user for the particular remainder subscription;
(g) transferring payment of the sales price provided in step (d) from at least one of (1) a registered account associated with the user containing purchase credits, (2) a user-provided credit card; and (3) a user authorized designated checking or debit account;
(h) notifying an offeror of a subscription that the particular remainder subscription has been transferred to the user; and
(i) providing the user who purchased the particular remainder subscription with at least one of an identifier and a password that enables a user to access the first remainder subscription purchased.

5. The method according to claim 4, wherein all of the remainder subscriptions on the buy list have been assigned to a common designee from a previous purchaser.

6. The method according to claim 5, wherein the common designee purchases remainder subscriptions for sale by an interested seller according to the following steps:
providing a user-updateable web page to receive information about the subscription offered for sale by an interested seller;
determining remaining value of the subscription and providing interested seller with a purchase offer having a price related to the remaining value;
after receiving an acceptance to the purchase offer, confirming ownership of the subscription with the offeror of the subscription, confirming transfer to the common designee, and providing the interested seller with credits to an authorized account, said credits permit purchases of other remainder subscriptions offered for sale by the designee; and
updating the buy list to include the remainder subscription purchased from the interested seller.

7. The method according to claim 6, wherein the confirming of ownership includes providing password or other information required to access the subscription, payment information and any identifying information required by the offeror of the subscription to confirm transfer to the common designee.

8. The method according to claim 1, wherein the buy list displays available remainder subscriptions, and wherein said an interested purchased searches for remainder subscriptions by one of subscription name, remaining term, and price.

9. The method according to claim 1, where the transaction charge applied in step (d) utilizes the following formula:
c*amount of credit used in purchase, wherein c=the decided percentage.

10. A method of transferring access to subscriptions and Internet pay sites, comprising the steps of:
(a) providing a web page for display by a registered user containing a buy list, said buy list comprising an inventory of one or more remainder subscriptions available for sale, wherein said buy list includes price and duration of remaining term;
(b) receiving a purchase request from the registered user for the particular remainder subscription;
(c) transferring payment of the sales price provided in step (d) from at least one of (i) a registered account associated with the user containing purchase credits, (ii) a user-provided credit card; and (iii) a user authorized designated checking or debit account;
(d) notifying the offeror of the subscription that the particular remainder subscription has been transferred to the user; and
(e) providing the user who purchased the particular remainder subscription with at least one of an identifier and a password that enables a user to access the first remainder subscription purchased.

11. The method according to claim 10, wherein the. remainder subscriptions on the buy list have been assigned to a common designee from one or more previous purchases.

12. A system for transferring access to subscriptions and Internet pay sites, said system comprising:
a database being accessible by a web server hosting a website for the transfer of online access to subscriptions and Internet pay sites;
a web server that provides communication between a third party entity and one or more registered users of the third party entity, said web server comprising:
a user management module that enables a user to provide registration, log in and update functions on a website that facilitates online transfer of remainder subscriptions;
an administration module that enables an administrator to log in to the website change information about registered users, change viewing authority of users, determine a remaining value of a remainder subscription to provide a purchase offer to an interested seller;
a buy module enabling the user to browse one or more pages of remainder subscriptions for sale and for enabling the user to select a particular remainder subscription for purchase; and
a sell module enabling a user to submit a request to sell a remainder subscription to the third party entity.

13. The system according to claim 12, wherein the user communicates with the website of the third party entity via TCP/IP.

14. The system according to claim 12, wherein each of the modules provide dynamic web pages for operation on the Microsoft.Net framework, using DHTML and ASP.NET.

15. The system according to claim 12, wherein the user module permits the user to provide payment information.

16. The system according to claim 12, wherein the administration module includes means to determine a current value of a subscription being sold by the common designee according to the following formula:
(1−y/x)(z) (1)
wherein y=number of days passed since the first remainder subscription started,
x=number of total days in duration for the first remainder subscription; and
z=price of the remainder subscription.

17. The system according to claim 16, wherein the administration module provides an offering price to a user interested in buying a remainder subscription based on the formula recited in claim 16 and a transaction charge based on a predetermined percentage of the current value.

18. The system according to claim 16, wherein the buyer module enables a user to purchase a remainder subscription with credit assigned to a registered account of the user.
